(19) United States
(12) Patent Application Publication
(10) Pub. No.: US 2009/0077122 A1
(43) Pub. Date: Mar. 19, 2009

(54) APPARATUS AND METHOD FOR DISPLAYING CANDIDATES

(75) Inventors: Kosei Fume, Kanagawa (JP); Yasuto Ishitani, Kanagawa (JP); Masaru Suzuki, Kanagawa (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/212,745

(22) Filed: Sep. 18, 2008

(30) Foreign Application Priority Data
Sep. 19, 2007 (JP) 2007-242377

(51) Int. Cl. G06F 17/30

(52) U.S. Cl. 707/103 R; 707/E17.045

(57) ABSTRACT

A candidate displaying apparatus includes: a content input unit that performs an input process on a content; a named entity extracting unit that extracts, from the content, named entities each identifying a specific object or a specific piece of information; an association degree calculating unit that calculates a degree of association between each of the named entities and a predetermined character string contained in the content; an associated information storage unit that stores therein the named entities, the character string, and the degrees of association in correspondence with one another; and a displaying unit that displays, on a display device, the named entities that are kept in correspondence with the character string as selectable candidates in descending order of the degrees of association thereof.

### CROSS-REFERENCE TO RELATED APPLICATIONS

This application is based upon and claims the benefit of priority from the prior Japanese Patent Application No. 2007-242377, filed on Sep. 19, 2007; the entire contents of which are incorporated herein by reference.

### BACKGROUND OF THE INVENTION

1. Field of the Invention

The present invention relates to a candidate displaying apparatus and a candidate displaying method for displaying selectable candidates.

2. Description of the Related Art

Conventionally, mobile phones have been used not only for making telephone calls, but also for sending and receiving electronic mail and browsing sites designed for accesses from mobile phones.

In recent years, the improvement in the level of performance of mobile phones achieved through technological innovation realizes many models of mobile phones provided with a Web browser. Mobile phones come to play a role of information terminals that have advanced functions, like Personal Computers (PCs) and Personal Digital Assistances (PDAs).

In addition to mobile phone terminals, an increasing number of devices come to have a function of network connection for information acquisition. When used as the information terminals, these devices are required to have an input interface which allows the user to easily search an enormous amount of information for a desired piece of information and to easily locate target information.

Methods that have been proposed for arriving at a desired site or a desired piece of information can be roughly classified into two types of methods as described below. One is a directory-type searching method by which the user looks for a desired site by following a hierarchical menu prepared by a content service. The other is a method by which the user accesses a desired piece of information by sequentially selecting one of linked keywords that are specified in a document or the like.

Further, as for methods for presenting information to which the user wishes to refer, various techniques have been proposed. For example, JP-A 2005-63245 (KOKAI) proposes a technique for complementing a candidate that has been input by the user, before presenting a related item.

However, the technique disclosed in JP-A 2005-63245 (KOKAI) requires that related pieces of information be associated with each other and stored in a storage unit in advance. These pieces of information are not optimized for each user. Thus, a problem remains that the user needs to perform operations in a similar manner to the conventional techniques, until a piece of information suitable for the user is displayed.

### SUMMARY OF THE INVENTION

According to one aspect of the present invention, a candidate displaying apparatus includes: an input unit that inputs document data; an extracting unit that extracts, from the document data, named entities each identifying a specific object or a specific piece of information; an calculating unit that calculates a degree of association indicating how strong an association is between each of the named entities and a predetermined character string contained in the document data; an associated information storage unit that stores therein the named entities, the character string, and the degrees of associations in correspondence with one another; and a candidate displaying unit that, when displaying the character string, displays the named entities in correspondence with the character string on a display device as selectable candidates in descending order of the degree of association thereof.

According to another aspect of the present invention, a candidate displaying method includes: performing an input process on document data; extracting, from the document data, named entities each identifying a specific object or a specific piece of information; calculating a degree of association indicating how strong an association is between each of the named entities and a predetermined character string contained in the document data; storing, the named entities, the character string, and the degrees of associations in correspondence with one another; and displaying, when displaying the character string on a display device, the named entities in correspondence with the character string as selectable candidate in descending order of the degree of association thereof.

### BRIEF DESCRIPTION OF THE DRAWINGS

FIG. 1 is a functional block diagram of a mobile phone terminal according to an embodiment;

FIG. 2 is a conceptual drawing of examples of impression expressions stored in an impression expression dictionary;

FIG. 3 is a conceptual drawing of examples of relation expressions stored in a relation expression dictionary;

FIG. 4 is a conceptual drawing of examples of results of a morpheme analysis performed on an electronic mail (i.e., e-mail) input history;

FIG. 5 is a flowchart of a procedure performed in a mobile phone terminal, up to a process in which information related to a displayed content is stored into an associated information storage unit;

FIG. 6 is a flowchart of a procedure performed by an impression expression extracting unit, up to a process in which impression expressions are extracted and associated with named entities;

FIG. 7 is a flowchart of a procedure performed by a relation expression extracting unit, up to a process in which relation expressions are extracted and assigned to named entities as attributes thereof;

FIG. 8 is a flowchart of a procedure performed by an association degree calculating unit to calculate, for each of named entities, a degree of association between the named entity and another named entity or a keyword;

FIG. 9 is a conceptual drawing in which named entities and the like that are associated with one another are laid out as evaluation target nodes;

FIG. 10 is a flowchart of a procedure performed by a mobile phone terminal, starting with a process in which a menu screen is displayed and up to a process in which one of selectable candidates that has been selected is received;

FIG. 11 is a drawing of an example of information extracted from associated information storage unit;

FIG. 12 is a drawing of a first example of screen transitions on a mobile phone terminal;

FIG. 13 is a drawing of a second example of screen transitions on a mobile phone terminal;

FIG. 14 is a drawing of a third example of screen transitions on a mobile phone terminal; and

FIG. 15 is a diagram of a hardware configuration of a mobile phone terminal.

### DETAILED DESCRIPTION OF THE INVENTION

Exemplary embodiments of a candidate displaying apparatus and a candidate displaying method according to the present invention will be explained in detail with reference to the accompanying drawings. In the description of the exemplary embodiments below, examples in which the candidate displaying apparatus is applied to a mobile phone terminal will be explained. The candidate displaying apparatus can be applied to any information processing apparatus that is used for conducting a search for information. For example, the candidate displaying apparatus can be applied to a PC or a PDA.

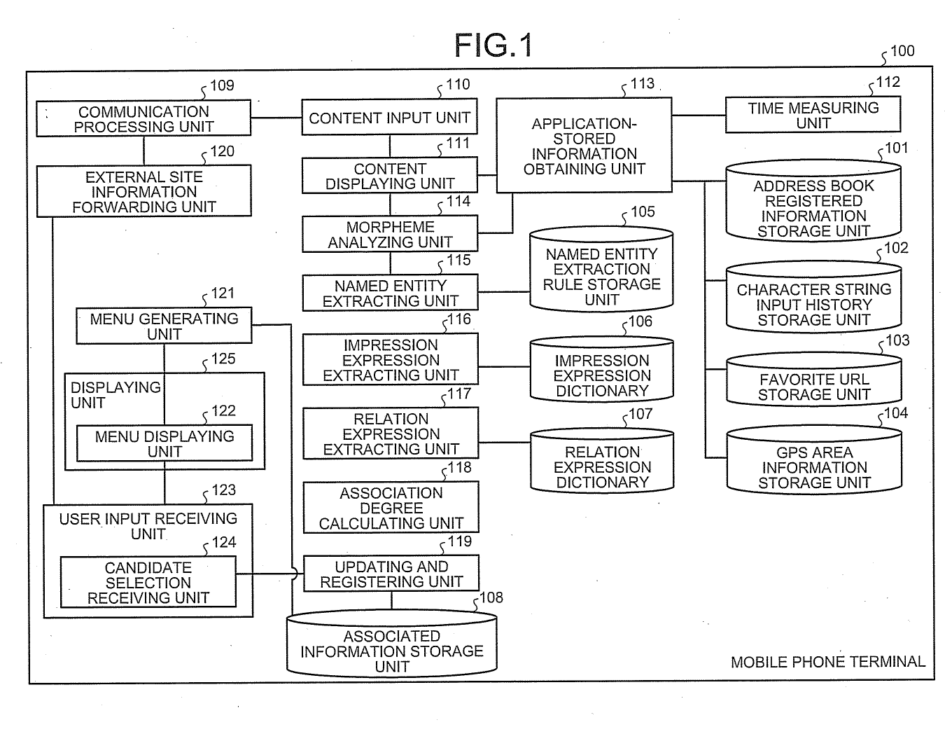

As shown in FIG. 1, a mobile phone terminal 100 according to a first embodiment includes an address book registered information storage unit 101, a character string input history storage unit 102, a favorite Uniform Resource Locator (URL) storage unit 103, a Global Positioning System (GPS) area information storage unit 104, a named entity extraction rule storage unit 105, an impression expression dictionary 106, a relation expression dictionary 107, an associated information storage unit 108, a communication processing unit 109, a content input unit 110, a content displaying unit 111, a time measuring unit 112, an application-stored information obtaining unit 113, a morpheme analyzing unit 114, a named entity extracting unit 115, an impression expression extracting unit 116, a relation expression extracting unit 117, an association degree calculating unit 118, an updating and registering unit 119, an external site information forwarding unit 120, a menu generating unit 121, a displaying unit 125, and a user input receiving unit 123.

Examples of a content displayed on the mobile phone terminal 100 include electronic mail (hereinafter, “e-mail”) that has been sent or received and information of sites publicized in external networks. The displayed content may be any document data that the user is able to browse.

The mobile phone terminal 100 calculates the degrees of association among pieces of information that have been input or referred to by the user. When the user searches for information on the mobile phone terminal 100, the mobile phone terminal 100 displays selectable candidates, putting a higher priority on a candidate with a higher degree of association.

The address book registered information storage unit 101 stores therein address book information that is used when the user makes phone calls on the mobile phone terminal 100. The address book information includes various types of personal data such as IDs, names, nicknames, phone numbers, and e-mail addresses of contacted parties, the relationships between the contacted parties and the user who owns the mobile phone terminal 100, and a history of dialed numbers.

The character string input history storage unit 102 stores therein a history of character strings that have been confirmed in a Kana-Kanji character conversion process and/or an auto complete process while the user creates e-mail messages and documents on the mobile phone terminal 100. (Note: “Kana” and “Kanji” are types of characters used in Japanese.) In addition, the character string input history storage unit 102 further stores therein what application program (hereinafter, “application”) or what service was being used when each of the character strings was input during the Kana-Kanji character conversion process and the auto complete process. Furthermore, in the case where any of the character strings has been input into a specific form, the character string input history storage unit 102 also stores therein the document that has been input into the form.

The favorite URL storage unit 103 stores therein the URLs and the names of the sites and the page titles that have been selected by the user as his/her favorite sites, from among the information of the sites that have been referred to by the user on the mobile phone terminal 100.

The GPS area information storage unit 104 stores therein map information that is used in a navigation process performed by a GPS (not shown) included in the mobile phone terminal 100. Another arrangement is acceptable in which the GPS area information storage unit 104 stores therein position information of positions in which the user has,input character strings or has made phone calls. With these arrangements, the mobile phone terminal 100 is able to calculate the degrees of association between each of the character strings that have been input by the user and the parties to which phone calls have been made by the user and each of the locations indicated in the map information.

The address book registered information storage unit 101, the character string input history storage unit 102, the favorite URL storage unit 103, and the GPS area information storage unit 104 are used for calculating the degrees of association between the character strings representing named entities and the like that are stored in these storage units and the named entities and the like that are contained in the contents displayed by the mobile phone terminal 100.

In this situation, a “named entity” denotes a character string that identifies a specific object or a specific piece of information. Examples of named entities include: proper nouns such as people's names and place names as well as unknown words and numeral expressions such as dates and money values.

The named entity extraction rule storage unit 105 stores therein an extraction rule used for extracting named entities from a result of a morpheme analysis. It is acceptable to use any well-known extraction rule as the extraction rule. Thus, the explanation thereof will be omitted.

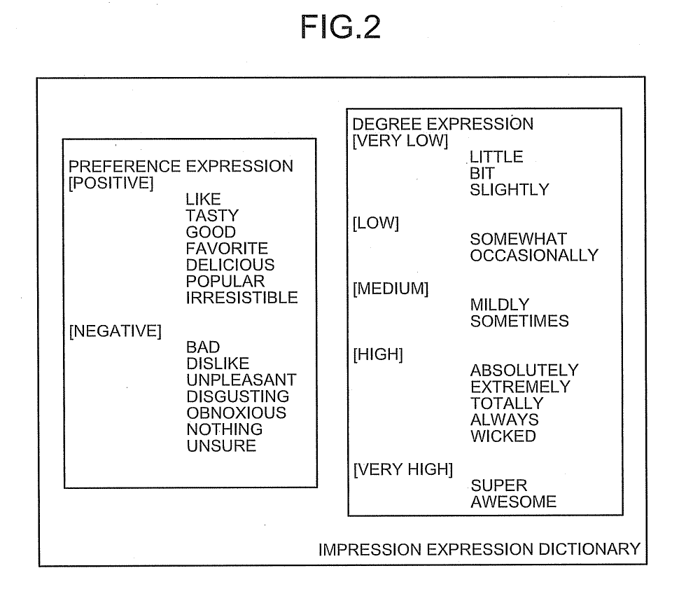

The impression expression dictionary 106 is a dictionary that stores therein impression expressions that are used as references for determining the user's impressions and evaluations of each of the extracted named entities. As shown in FIG. 2, the impression expressions include preference expressions and degree expressions. The preference expressions are expressions that are used as references for determining whether the user has a good impression of each of the named entities. The degree expressions are expressions that are used as references for determining the magnitude of the user's impression of each of the named entities. For example, in the case where e-mail messages contain preference expressions such as “like”, “tasty”, “good”, “favorite”, “delicious”, “popular”, and “irresistible”, it is possible to determine that the user has a good impression of the named entity that is positioned in the surroundings of each of the preference expressions.

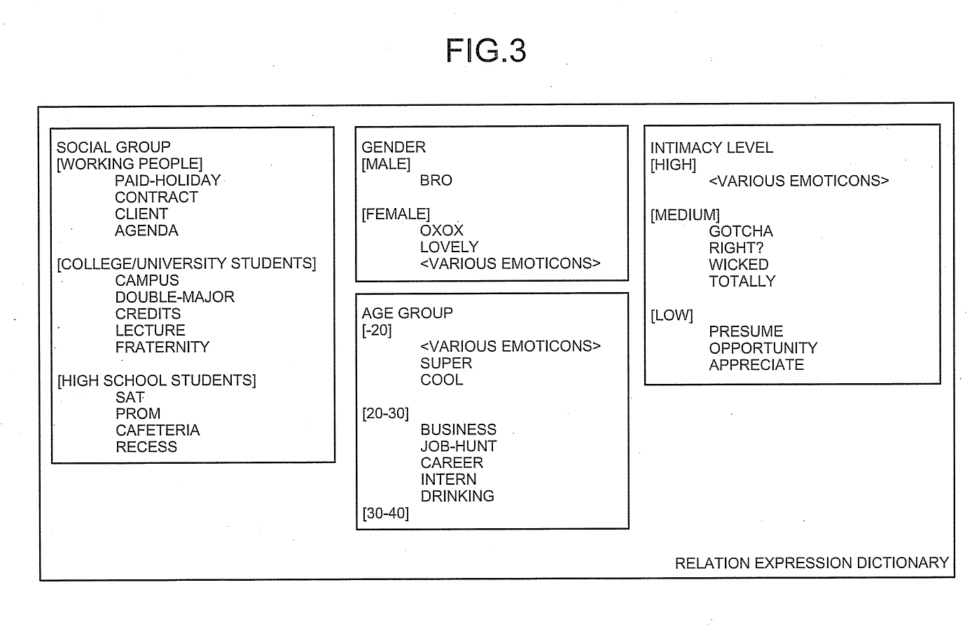

The relation expression dictionary 107 stores therein expressions that are used as references for associating each of the named entities with another named entity or the like. As shown in FIG. 3, the relation expression dictionary 107 stores therein expressions that are used as references for determining the social group, the gender, the age group, and the intimacy level to be associated with each of the named entities. For example, in the case where e-mail messages contain relation expressions such as “paid holiday”, “contract”, “client”, and “agenda”, it is possible to associate “working people” with the named entities that are positioned in the surroundings of each of the relation expressions.

The associated information storage unit 108 stores therein the named entities on which the associating process has been performed by the mobile phone terminal 100, together with character strings containing other named entities and the degrees of association between the named entities and the character strings containing the other named entities, while keeping them in correspondence with one another. In addition, the associated information storage unit 108 also stores therein the attributes that have been assigned to the character strings representing named entities and the like, while keeping the attributes and the named entities in correspondence with one another. It is acceptable to use any storing method as long as the associated information storage unit 108 is able to store therein the correspondence relationships. The details of the storing method will be explained later.

Furthermore, the associated information storage unit 108 also stores therein attribute information of the user. Examples of the attribute information of the user include the age, the gender, the social group (e.g., working people, college/university students, high school students) to which he/she belongs, the living areas (i.e., the place names), and the locations he/she visits often.

The dictionaries and the storage units described above are configured with one or more Hard Disk Drives (HDDs); however, it is acceptable to configure the dictionaries and the storage units with any other commonly-used storage means such as optical disks, memory cards, Random Access Memories (RAMs), and the like.

The communication processing unit 109 establishes a connection to an external server or the like via a network and transmits and receives information to and from the server or the like.

The content input unit 110 performs an input process on a content to be displayed for the user. Examples of the input content include web pages that have been obtained from the external server or the like via the communication processing unit 109 and e-mail messages that have been sent and received.

The content displaying unit 111 displays the content that has been input. The content displaying unit 111 outputs the displayed content to the application-stored information obtaining unit 113 and the morpheme analyzing unit 114. The time measuring unit 112 measures the current time.

The application-stored information obtaining unit 113 obtains information associated with the content displayed by the content displaying unit 111 from the current time measured by the time measuring unit 112, the address book registered information storage unit 101, the character string input history storage unit 102, the favorite URL storage unit 103, and the GPS area information storage unit 104. The obtained information will be referred to as application-stored information. In other words, as the application-stored information, the application-stored information obtaining unit 113 is able to obtain information such as the information of the supplier of the content as well as information related to the specifics of the services, the titles, and the browsing times.

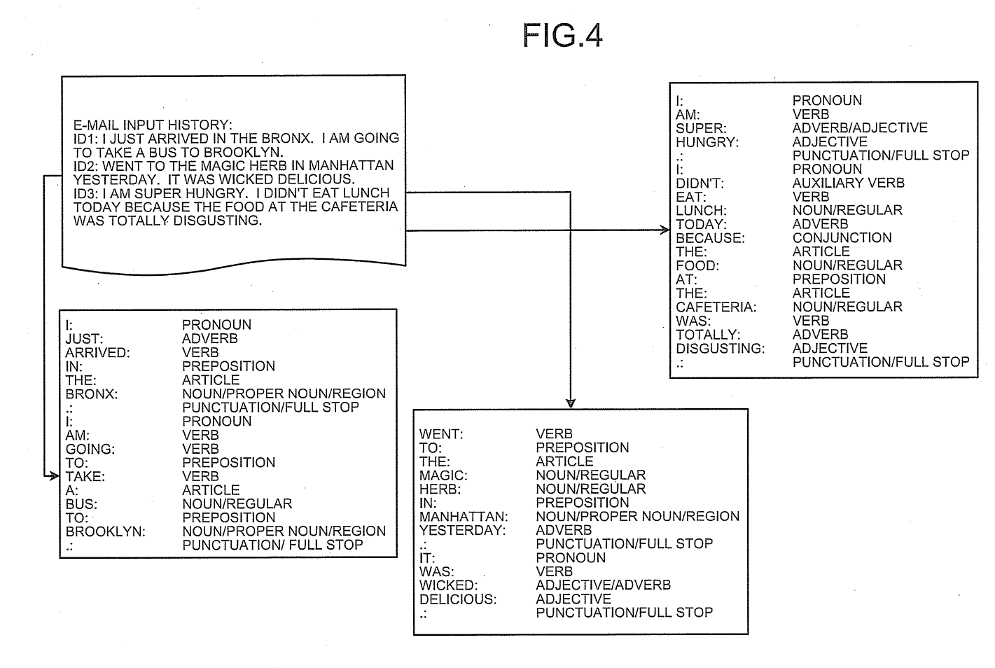

The morpheme analyzing unit 114 performs a morpheme analysis on the displayed content and the application-stored information. For example, in the case where the content is e-mail messages, the morpheme analyzing unit 114 performs a morpheme analysis on the e-mail messages stored in the input history as shown in FIG. 4 and obtains a result of the morpheme analysis.

The named entity extracting unit 115 extracts named entities including unknown words, by applying a named entity extracting technique on the result of the morpheme analysis and referring to the extraction rule stored in the named entity extraction rule storage unit 105. In addition, the named entity extracting unit 115 also identifies the meaning of each of the named entities, as much as possible. For example, based on the result of the morpheme analysis shown in FIG. 4, the named entity extracting unit 115 identifies each of the extracted named entities such as “The Bronx”, “Brooklyn”, and “Manhattan” as a place name. Further, the named entity extracting unit 115 identifies “bus” as a means of transportation and “today” as a time expression.

The impression expression extracting unit 116 extracts impression expressions from the content and the application-stored information, by referring to the impression expression dictionary 106 and associates the extracted impression expressions with the named entities that have been extracted by the named entity extracting unit 115. As a result, it is possible to assign the user's impressions and evaluations of the named entities to the extracted named entities. The impression expressions that have been associated with the named entities in this manner are used for calculating the degrees of association between the named entities and the character strings containing other named entities and the like.

The relation expression extracting unit 117 extracts relation expressions from the content and the application-stored information, by referring to the relation expression dictionary 107 and assigns the attributes represented by the extracted relation expressions to the named entities that have been extracted by the named entity extracting unit 115. Examples of the relation expressions and the attributes that correspond to the relation expressions will be explained later.

The association degree calculating unit 118 associates named entities with character strings representing other named entities and the like, by using the extracted named entities, the impression expressions, and the information (e.g., the character strings representing other named entities and the like) stored in the associated information storage unit 108. The method used in the associating process will be explained later. In addition, the association degree calculating unit 118 calculates the weights (i.e., the degrees of association) between the named entities and the character strings representing other named entities and the like that have been associated with one another. The method used for calculating the weights will be explained later.

Each of the degrees of association is expressed with a variable number. The stronger the association between a named entity and another named entity or a keyword is, the higher the value of the variable expressing the degree of association is.

In the case where any of the named entities and the like on which the associating process has been performed by the association degree calculating unit 118 has not yet been stored in the associated information storage unit 108, the updating and registering unit 119 registers such a named entity into the associated information storage unit 108, together with the degrees of association between such a named entity and other named entities and the like. In addition, in the case where any of the named entities and the like on which the associating process has been performed by the association degree calculating unit 118 have already been stored in the associated information storage unit 108, the updating and registering unit 119 updates the associated information storage unit 108 by, for example, adding the calculated degrees of association to the associated information storage unit 108. As a result, the named entities contained in the content to which the user has referred to are stored in the associated information storage unit 108, together with the relationships between the named entities and the character strings representing other named entities and the like. Further, the most updated results from the user's referring to the content are also stored in the associated information storage unit 108.

Further, in the case where an attribute (i.e., a relation expression) is assigned to any of the named entities, the updating and registering unit 119 registers such a named entity and the attribute thereof into the associated information storage unit 108, while keeping them in correspondence with each other.

The menu generating unit 121 generates a menu screen that contains selectable candidates from which the user is able to select. It is assumed that the selectable candidates shown on the menu screen contain the named entities and the like that have been stored in the associated information storage unit 108. The selectable candidates are arranged in descending order of the degrees of association among the named entities displayed as the selectable candidates. Specific examples of the screens will be explained later.

The displaying unit 125 includes a menu displaying unit 122. The displaying unit 125 displays information on a display device included in the mobile phone terminal 100.

The menu displaying unit 122 displays the generated menu screen on the display device. In addition, on a menu screen being displayed on the display device and showing a character string representing a named entity or the like as a title, the menu displaying unit 122 displays, as selectable candidates, the character strings representing other named entities and the like that have been associated with the character string shown as the title, in descending order of the degrees of association thereof.

Further, in the case where any of the attributes of the character strings displayed as the selectable candidates matches the attribute of the user, the menu displaying unit 122 applies a visual effect to such a selectable candidate and displays the selectable candidates on the display device.

The user input receiving unit 123 includes a candidate selection receiving unit 124. The user input receiving unit 123 receives an input from the user via an input device (not shown) that is included in the mobile phone terminal 100.

The candidate selection receiving unit 124 receives one of the selectable candidates displayed on the menu screen that has been selected. After that, the updating and registering unit 119 updates, for example, the degree of association for the named entity represented by the selected one of the selectable candidates.

Via the communication processing unit 109, the external site information forwarding unit 120 specifies the one of the selectable candidates that has been selected by the user as a keyword, and also adds more keywords that can be used in a search to the selected one of the selectable candidates and forwards the information to an external site. As a result, a search engine is able to conduct a search by using the appropriate keywords.

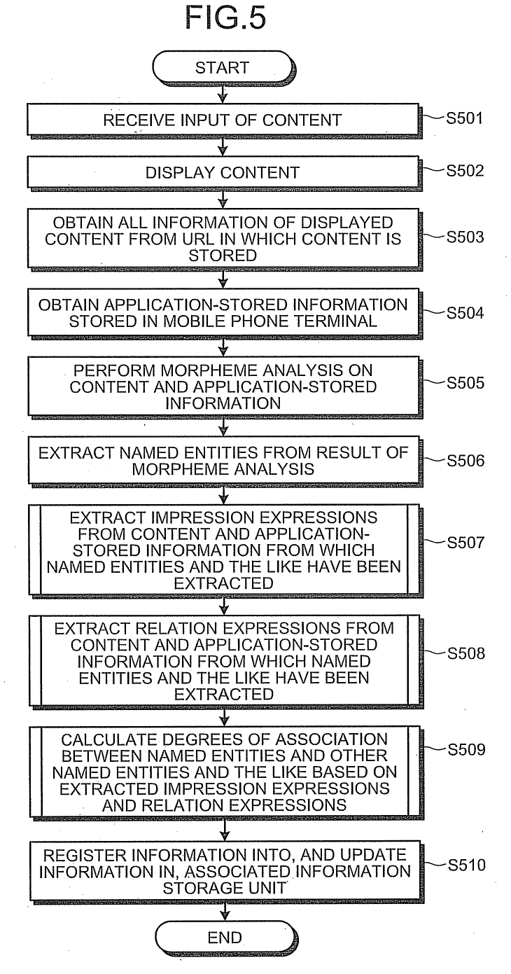

Next, a processing procedure performed by the mobile phone terminal 100, up to a process in which the information related to the displayed content is stored into the associated information storage unit 108, will be explained with reference to FIG. 5.

First, the content input unit 110 receives an input of a content from an external network via the communication processing unit 109 (step S501).

After that, the content displaying unit 111 displays the input content for the user (step S502).

Subsequently, the content input unit 110 obtains, as necessary, all the information of the displayed content via the communication processing unit 109 (step S503). For example, in the case where comments or the like are omitted from the site from which the content has been obtained, the content input unit 110 obtains the omitted comments or the like.

After that, the application-stored information obtaining unit 113 obtains information associated with the content displayed by the content displaying unit 111 from the current time measured by the time measuring unit 112, the address book registered information storage unit 101, the character string input history storage unit 102, the favorite URL storage unit 103, and the GSP area information storage unit 104 (step S504). The obtained information is assumed to be application-stored information that is stored in the mobile phone terminal 100.

Subsequently, the morpheme analyzing unit 114 performs a morpheme analysis on the content and the application-stored information that have been obtained (step S505).

After that, the named entity extracting unit 115 extracts named entities from the result of the morpheme analysis by using the named entity extraction rule storage unit 105 (step S506). Also, the named entity extracting unit 115 extracts character strings (i.e., nouns and the like) on which the associating process will be performed, from the result of the morpheme analysis. Examples of the extracted character strings are “curry”, “bus”, and the like.

After that, the impression expression extracting unit 116 extracts impression expressions from the content and the application-stored information from which the named entities have been extracted (step S507).

Subsequently, the relation expression extracting unit 117 extracts relation expressions from the content and the application-stored information from which the named entities have been extracted (step S508).

After that, the association degree calculating unit 118 calculates the degrees of association between the extracted named entities and the character strings representing other named entities and the like, based on the extracted impression expressions and the extracted relation expressions (step S509).

Subsequently, in the case where any of the named entities and the like on which the associating process has been performed by the association degree calculating unit 118 has not yet been stored in the associated information storage unit 108, the updating and registering unit 119 registers such a named entity into the associated information storage unit 108, together with the degrees of association between such a named entity and other named entities and the like. In addition, in the case where the named entities and the like on which the associating process has been performed by the association degree calculating unit 118 have already been stored in the associated information storage unit 108, the updating and registering unit 119 updates the associated information storage unit 108 with the degrees of association that have been calculated (step S510).

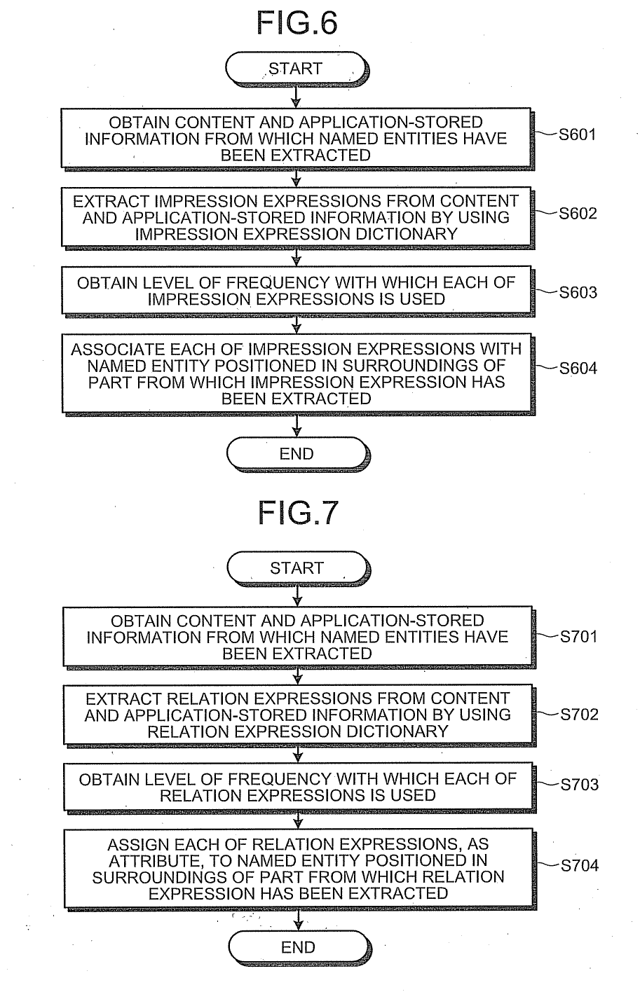

As a result of the processing procedure described above, the information that has been extracted from the content to which the user has referred is now stored in the associated information storage unit 108. Next, the procedure for extracting the impression expressions performed at step S507 shown in FIG. 5 will be explained, with reference to FIG. 6.

First, the impression expression extracting unit 116 obtains the content and the application-stored information out of which the named entities have been extracted, from the named entity extracting unit 115 (step 5601).

After that, by using the impression expression dictionary 106, the impression expression extracting unit 116 extracts impression expressions from the content and the application-stored information out of which the named entities have already been extracted (step S602). The method used for extracting the impression expressions may be, for example, pattern matching with the impression expressions stored in the impression expression dictionary 106.

After that, the impression expression extracting unit 116 obtains the level of frequency with which each of the impression expressions has been extracted (step S603). Subsequently, the impression expression extracting unit 116 stores therein the result of the pattern matching process and the level of frequency of extraction, together with the content and the application-stored information from which the impression expressions have been extracted.

As for the extracted impression expressions, for example, in the case where an impression expression “delicious” has been extracted from the e-mail input history as shown in FIG. 4, it is understood that the impression expression “delicious” corresponds to the “Positive” group of the preference expressions defined in the impression expression dictionary 106. As another example, in the case where an impression expression “wicked” has been extracted, it is understood that the impression expression “wicked” corresponds to the “High” group of the degree expressions defined in the impression expression dictionary 106. These impression expressions are stored in such a manner that it is possible to identify their positions in the content and the application-stored information from which they have been extracted.

After that, the impression expression extracting unit 116 brings each of the impression expressions into correspondence with a character string representing a named entity or the like that is positioned in the surroundings of the part from which the impression expression has been extracted (step S604). It is judged whether any character string should be brought into correspondence with each of the impression expressions based on, for example, the distance between the character string and the impression expression.

In the example of the e-mail input history as shown in FIG. 4, the extracted impression expressions are brought into correspondence with the character strings (e.g., “Magic Herb”, “Manhattan”, “yesterday”) representing named entities and the like including unknown words and being positioned in the surroundings of the extracted impression expressions. Further, each of the extracted impression expressions is stored together with the level of frequency with which the impression expression is extracted, the main body of the e-mail message on which the analysis has been performed, the ID, and the information of Mr. “Johnson” who is presumed to be the addressee of the e-mail message.

Next, the procedure for extracting the relation expressions performed at step S508 shown in FIG. 5 will be explained, with reference to FIG. 7.

First, the relation expression extracting unit 117 obtains the content and the application-stored information out of which the named entities have been extracted, from the named entity extracting unit 115 (step S701).

After that, by using the relation expression dictionary 107, the relation expression extracting unit 117 extracts relation expressions from the content and the application-stored information out of which the named entities have already been extracted (step S702). The method used for extracting the relation expressions may be, for example, pattern matching with the relation expressions stored in the relation expression dictionary 107.

After that, the relation expression extracting unit 117 obtains the level of frequency with which each of the relation expressions has been extracted (step S703). Subsequently, the relation expression extracting unit 117 stores therein the result of the pattern matching process and the level of frequency of extraction, together with the content and the application-stored information from which the relation expressions have been extracted.

Subsequently, for each of the relation expressions, the relation expression extracting unit 117 assigns an attribute corresponding to the relation expression to a character string representing a named entity or the like that is positioned in the surroundings of the part from which the relation expression has been extracted (step S704). It is judged whether the attribute should be assigned to any character string based on, for example, the distance between the character string and the relation expression. Next, the attribute corresponding to each of the relation expressions will be explained.

For example, when the relation expression dictionary 107 as shown in FIG. 3 is used and in the case where the relation expression extracting unit 117 has extracted a relation expression such as “paid-holiday”, “contract”, or “client” from a content and application-stored information, the relation expression extracting unit 117 identifies “working people” as the corresponding attribute in the “social group” relation. As another example, in the case where the relation expression extracting unit 117 has extracted a relation expression such as “campus” or “credits” from a content and application-stored information, the relation expression extracting unit 117 identifies “college/university students” as the corresponding attribute. As yet another example, in the case where the relation expression extracting unit 117 has extracted relation expressions such as “SAT” or “prom”, the relation expression extracting unit 117 identifies “high school students” as the corresponding attribute.

The relation expression extracting unit 117 also performs the extraction process with regard to the relations other than the “social group” relation. As shown in FIG. 3, the relations other than the “social group” relation are, for example, “gender”, “age group”, and “intimacy level”. The relation expression extracting unit 117 identifies a corresponding attribute based on each of the extracted relation expressions, like in the example of the “social group” described above.

For example, when having extracted a relation expression such as “cool” or “super (hungry)”, the relation expression extracting unit 117 identifies the “age group” as “less than 20 years old (−20)”. As another example, when having extracted a relation expression such as “business” or “drinking”, the relation expression extracting unit 117 identifies the “age group” as “older than 20 and younger than 30 (20-30)”.

Further, with the criterion of “intimacy level”, the relation expression extracting unit 117 identifies the attribute for the intimacy level as “High” when many emoticons are used in the document, identifies the intimacy level attribute as “Medium” when a casual expression such as “gotcha” or “right?” is used, and identifies the intimacy level attribute as “Low” when a formal expression such as “presume” or “opportunity” is used.

When one or more of the relation expressions stored in the relation expression dictionary 107 have been extracted from a content or application-stored information, the relation expression extracting unit 117 assigns the identified attribute to the content, the application-stored information, and a character string representing a named entity or the like that is positioned in the surroundings of each of the relation expressions.

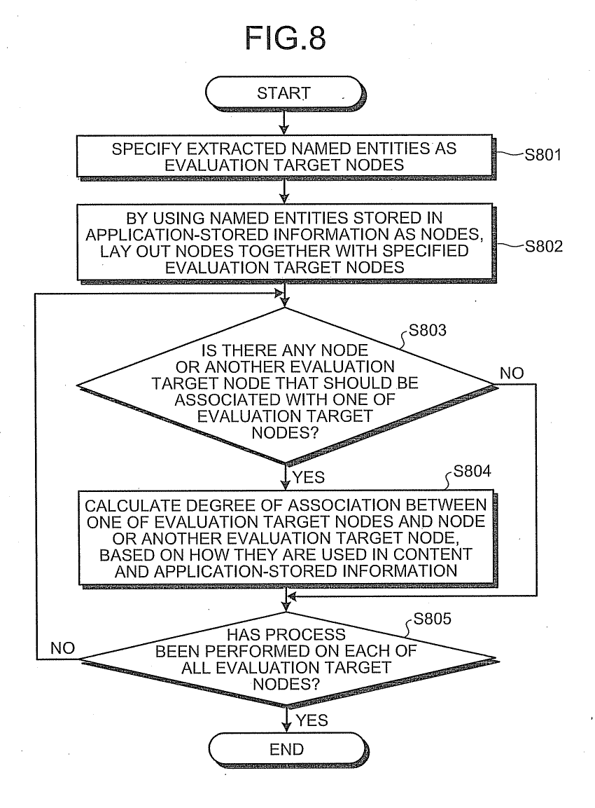

Next, the procedure for calculating the degrees of association that is performed at step S509 shown in FIG. 5 will be explained, with reference to FIG. 8.

First, the association degree calculating unit 118 specifies the named entities that have been extracted from the content as evaluation target nodes (step S801). In that situation, it is acceptable to specify all of the named entities and the keywords that have been extracted from the content as the evaluation target nodes. Alternatively, by employing a statistical process that uses, for example, term frequency/inverse document frequency (tf/idf), it is acceptable to specify only the named entities that are judged to be important as the evaluation target nodes.

After that, by using the named entities and the like that are stored in the application-stored information as nodes, the association degree calculating unit 118 lays out the nodes, together with the specified evaluation target nodes (step S802).

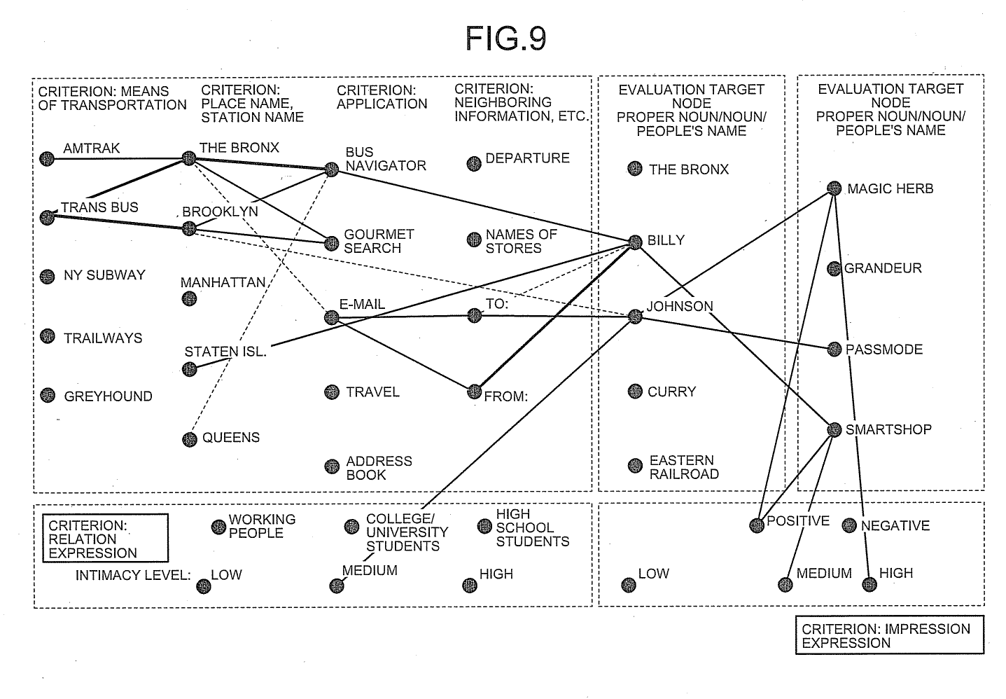

As shown in FIG. 9, the nodes and the evaluation target nodes that have been laid out are arranged in appropriate positions according to the criteria and the classification of the evaluation target nodes. As examples of the nodes obtained from the application-stored information, “The Bronx”, “Brooklyn”, “Manhattan”, “Staten Isl”., and “Queens” are arranged under “place name” as a criterion. As examples of the applications (i.e., services) that are stored in the mobile phone terminal 100, “Bus Navigator”, “Gourmet Search”, “E-mail (i.e., a mailer)”, “Travel (i.e., a site)”, and “Address book (locally stored in the mobile phone)” are arranged. As examples of neighboring information for these words, other words that are positioned in the vicinity or the surroundings of these words are arranged (e.g., “departure”, “names of stores”, “To:”, and “From:”).

It is assumed that the evaluation target nodes and the keywords that are used as the targets of evaluations include: “The Bronx”, “Billy”, “Johnson”, “curry”, “Eastern Railroad”, “Magic Herb”, “Grandeur”, “Passmode”, and “Smartshop”.

In addition, the association degree calculating unit 118 also lays out the relation expressions and the impression expressions as nodes. For example, as for the relation expressions, the association degree calculating unit 118 lays out “working people”, “college/university students”, and “high school students” indicating the “social groups”. Also, as other examples with the relation expressions, the association degree calculating unit 118 lays out “High”, “Medium”, and “Low” indicating the “intimacy levels”. In addition, as for the impression expressions, the association degree calculating unit 118 lays out “Positive” and “Negative”, as well as “High”, “Medium”, and “Low” that serve as degree expressions.

After that, the association degree calculating unit 118 judges, for each of the evaluation target nodes, whether there is a node or another evaluation target node that should be associated with the evaluation target node (step S803). It is acceptable to use any standard to judge whether two or more of the nodes should be associated with one another. For example, it is acceptable to make judgment based on whether two or more of the nodes appeared in a co-occurring manner or whether two or more of the nodes are used in mutually the same application.

As a more specific example, in the case where a character string that is identical to one of the nodes that have been laid out is contained in a content, the association degree calculating unit 118 associates the node with an evaluation target node that has been extracted from the content. Also, in the case where an evaluation target node is an addressee of an e-mail message, the association degree calculating unit 118 associates the evaluation target node with “To:”. Further, in the case where two or more evaluation target nodes have been extracted from mutually the same content, the association degree calculating unit 118 associates the evaluation target nodes with one another. As explained above, the association degree calculating unit 118 associates the nodes shown in FIG. 9 with one another, based on the contents and the application-stored information. The degrees of association are calculated for the nodes that have been associated with one another, by performing a process described later.

In the case where the association degree calculating unit 118 has judged that there is no node or other evaluation target node that should be associated with each of the evaluation target nodes (step S803: No), the association degree calculating unit 118 performs no particular process.

On the contrary, in the case where the association degree calculating unit 118 has judged that there are one or more nodes or other evaluation target nodes that should be associated with each of the evaluation target nodes (step S803: Yes), the association degree calculating unit 118 calculates the degrees of association by assigning a weight between each of the evaluation target nodes and the one or more nodes or other evaluation target nodes that are associated with the evaluation target node (step S804).

For example, “Billy” is associated with the “From:” section of “E-mail”, while “Smartshop” is mentioned in the e-mail message, and also the evaluation thereof is “Positive” and “Medium”. Thus, the association degree calculating unit 118 assigns weights to the relationships among these words, so that the degrees of association thereof are higher than the degrees of association of the relationships among other nodes.

As another example, Mr. “Johnson” has a high degree of association with the “To:” section of “E-mail”, and the specifics are associated with “Magic Herb” and “Passmode”. Of those words, a weight corresponding to “Positive” and “High” is assigned to “Magic Herb”.

As explained above, according to the present embodiment, the impression expressions are used as references for determining whether a large weight should be assigned. In other words, it is judged whether the relationship is “Positive”, based on whether a preference expression is contained. Also, it is judged whether the association is strong, based on which degree expression is contained. Next, a formula used for calculating the weights (i.e., the degrees of association) for the evaluation target nodes will be explained.

$$W ( {N}_{i} , {N}_{s} ) = {p}_{i} {\sum }_{k = 1}^{n} ( {R}_{s} ) ( {N}_{k} ) + {f}_{i} \qquad ( 1 )$$

In Formula (1), W(Ni, Ns) denotes a value of a weight assigned to an evaluation target node (Ni), with respect to a node (Ns) corresponding to a criterion. The variable “n” denotes the number of links connected to the evaluation target node. The variable “Rs” is a value obtained by quantifying an intimacy level or a degree. For example, it is assumed that the values {10, 5, 1} are assigned to the degree expressions {High, Medium, Low} described above.

The variable “pi” is a bias value that is specified for each of the different types of evaluation target nodes. For example, a larger weight is assigned to an evaluation target node that is judged in advance as a proper noun or a place name than to an evaluation target node that is a word made by joining two words together (or joining two Katakana words together in Japanese), which is treated as an unknown word. As a result, it is possible to present more reliable information when the information is output.

The variable “fi” denotes the frequency with which each vocabulary word is used in an evaluation target node (Ni). The variable “fi” is based on a heuristic implying that the higher the frequency with which an item appears is, the more important the item is.

The method for assigning the weights (i.e., calculating the degrees of association) is not limited to the example that uses the formula above. It is acceptable to use any other methods. For example, another arrangement is acceptable in which the elements are narrowed down by applying a restriction to the conditions under which the weights are assigned so that the relationships among only the three elements having higher priorities are indicated.

Returning to the description of FIG. 8, the association degree calculating unit 118 judges whether the process to calculate the degrees of association has been finished for all of the evaluation target nodes (step S805). In the case where the association degree calculating unit 118 has judged that the calculation process has not been finished for all the evaluation target nodes (step S805: No), the association degree calculating unit 118 starts the process again from step S803.

On the contrary, in the case where the association degree calculating unit 118 has judged that the process to calculate the degrees of association has been finished for all the evaluation target nodes (step S805: Yes), the process ends.

As a result of the processing procedure described above, the evaluation target nodes that have been associated with nodes and other evaluation target nodes are now stored in the associated information storage unit 108, together with the degrees of association.

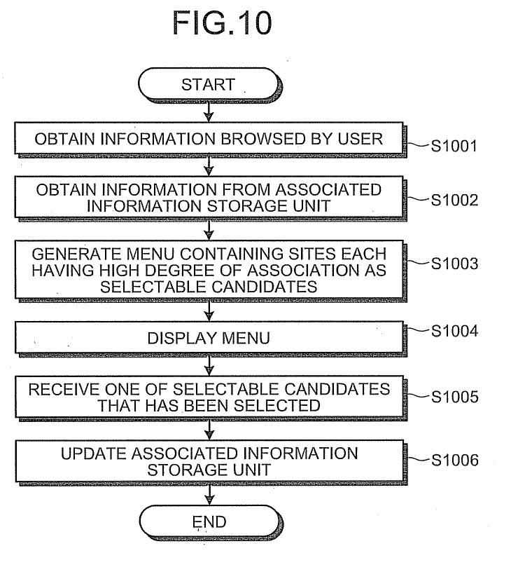

Next, a procedure performed by the mobile phone terminal 100 for displaying a menu by using the information stored in the associated information storage unit 108 will be explained, with reference to FIG. 10.

It is assumed that the user has been using an arbitrary application provided by the mobile phone terminal 100. When the user has finished using the application, the menu generating unit 121 obtains the information that has been browsed and created by the user while the application was being used (step S1001).

After that, to generate a menu, the menu generating unit 121 obtains the information stored in the associated information storage unit 108 (step S1002).

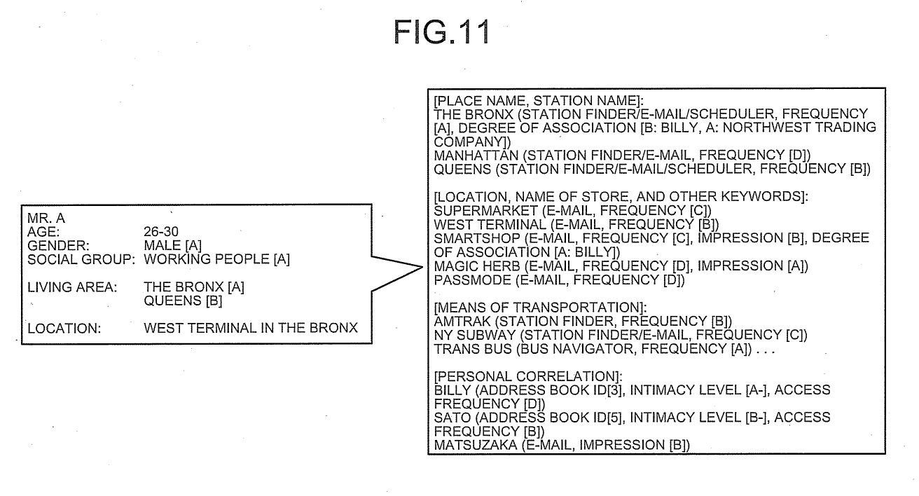

As shown in FIG. 11, in the case where the mobile phone terminal 100 is used by Mr. A, the menu generating unit 121 obtains the character strings representing named entities and the like that are stored in the associated information storage unit 108, together with the other character strings that have been associated therewith and the degrees of association.

For example, named entities such as “The Bronx”, “Manhattan”, and “Queens” are obtained as “place names and station names”. As for the situation in which each of the named entities was used, “The Bronx” was used while “Station Finder”, “E-mail” or a “scheduler” was being used; “Manhattan” was used while the “Station Finder” or “E-mail” was being used; and “Queens” was used also while the “Station Finder”, “E-mail” or “scheduler” was used. Further, the frequency with which each of the named entities is used is indicated with one of the grades from “A” to “E”. Also, in the example with the mobile phone terminal 100 used by Mr. A, it is observed that, as keywords that are associated with the place names, “Billy” and “Northwest Trading Company” are associated with the place name “The Bronx”. The grades “A” to “E” indicating the degrees of association correspond to five different levels based on the values that have been calculated in the process described above.

Named entities such as “supermarket”, “West Terminal”, and “Smartshop” have been obtained as “Location, Names of Store, and Other keyword”. Also, to each of these named entities, the name of the application in which the named entity was used, the information regarding the frequency, and the degree of association are assigned. For example, it is observed that “Smartshop” was used while the “E-mail” was being used, and the level of frequency is low, and the impression is “B”. It is also observed that “Smartshop” has a high degree of association (indicated with the grade “A”) with “Billy”.

Further, the menu generating unit 121 is also able to extract corresponding named entities and arrange them in a list by using the other criteria such as “means of transportation” and “personal correlations”. In addition, even if some criteria are not provided as headings in the result of extraction, the mobile phone terminal 100 is able to collect the weights assigned to the attributes and the associated words by using the criteria with which the relations are stored because the nodes and the link relationships are stored in the associated information storage unit 108 as a result of the processing procedure shown in FIG. 5.

As for the format of the list that has been obtained, in the example shown in FIG. 11, the degrees of association and the levels of frequency are indicated with the grades “A” to “E” corresponding to the five levels so that the readability is enhanced; however, another arrangement is acceptable in which the degrees of association and the levels of frequency are obtained as numerical values, in consideration of the processes performed afterwards.

Subsequently, based on the information obtained at step S1002, the menu generating unit 121 generates a menu in which the named entities and the like are presented as selectable candidates in descending order of the degrees of association thereof (step S1003). The presented named entities have high degrees of association with the named entities contained in the information that was browsed and created by the user while the application was being used and has been obtained at step S1001.

Subsequently, the menu displaying unit 122 displays the generated menu on the display device (step S1004). After that, the candidate selection receiving unit 124 receives one of the selectable candidates that has been selected by the user from the displayed menu (step S1005).

Subsequently, of the information stored in the associated information storage unit 108, the updating and registering unit 119 updates, with higher values, the values indicating the degrees of association between the named entities and the like contained in the information that was browsed and created by the user while the application was being used and has been obtained at step S1001 and the named entity indicated in the one of the selectable candidates that has been selected (step S1006).

As a result of the processing procedure described above, the selectable candidates each of which has a high degree of association with the user are displayed on the menu screen in an order. Further, because the degrees of association of the one of the selectable candidates that has been selected are updated, the level of precision regarding the degrees of association within the information stored in the associated information storage unit 108 is improved.

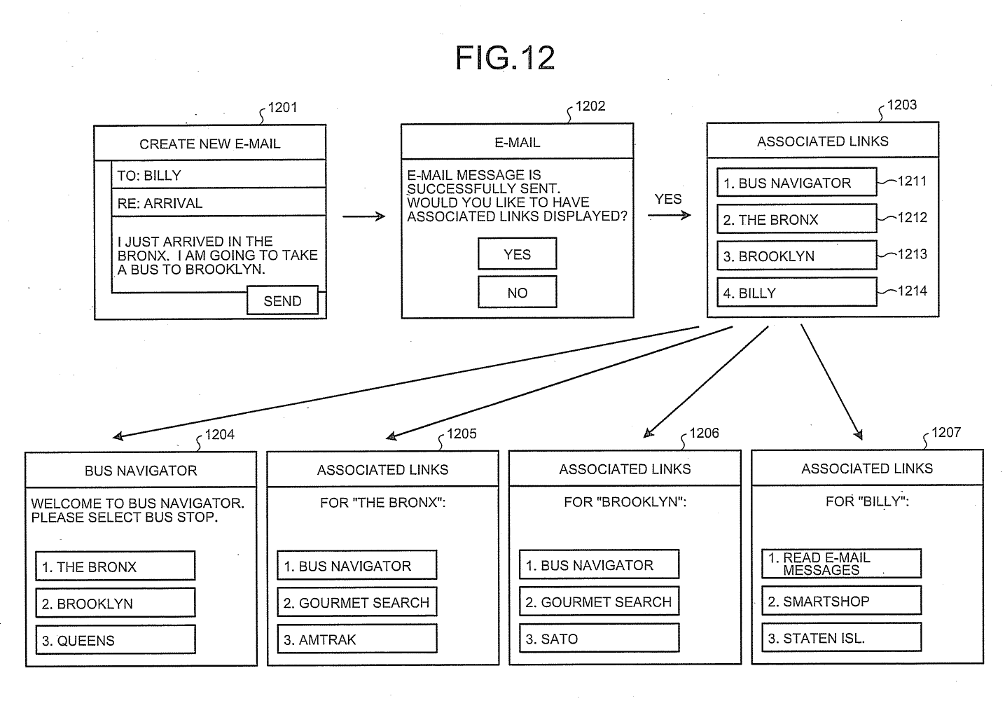

Next, an example in which the information stored in the associated information storage unit 108 is utilized will be explained. First, transitions of the screens that are presented according to the processing procedure shown in FIG. 10 will be explained, with reference to FIG. 12.

It is assumed that, first, the user has created an e-mail message addressed to “Billy” by using an e-mail creating function included in the mobile phone terminal 100, as shown on a screen 1201. After having sent the e-mail message, the mobile phone terminal 100 displays a screen 1202 and asks the user whether he/she wishes to have “associated links” displayed.

In the case where a permit to display the “associated links” has been obtained, the menu generating unit 121 extracts “The Bronx”, “Brooklyn”, “bus”, “Billy”, and “(Date and Time of Creation)” as named entities and keywords, out of the information obtained from the e-mail creating function. After that, the menu generating unit 121 generates a menu screen by using the information obtained from the associated information storage unit 108, so that the menu displaying unit 122 displays the generated menu screen 1203. The order in which the named entities and the keywords are arranged in the display may be determined based on, for example, the levels of frequency thereof.

In the example with the menu screen 1203 shown in FIG. 12, it is assumed that the following sites and keywords are displayed: “1. Bus Navigator” has been extracted from the category of means of transportation, based on the information of the levels of frequency shown in FIG. 11 and the keyword “bus”; “2. The Bronx” and “3. Brooklyn” have been extracted out of the named entities contained in the main body of the e-mail message; and “4. Billy” has been extracted from the “To:” section of the e-mail message.

Next, what will happen when each of the selectable candidates has been selected will be explained. In the case where “1. Bus Navigator” indicated with the reference character 1211 has been selected, the menu displaying unit 122 switches the screen to the corresponding site based on the URL information of the site of the Bus Navigator. In this situation, the external site information forwarding unit 120 forwards, to the site, the place names each of which has a high degree of association with the Bus Navigator. As a result, as shown on a screen 1204, place names are displayed as the selectable candidates in descending order of the degrees of association thereof.

As another example, in the case where “2. The Bronx” indicated with the reference character 1212 or “3. Brooklyn” indicated with the reference character 1213 has been selected out of the selectable candidates, the menu displaying unit 122 displays applications (i.e., services) and keywords each of which has a high degree of association with the selected one of the selectable candidates in an order, as shown on a screen 1205 or a screen 1206.

As yet another example, in the case where “4. Billy” indicated with the reference character 1214 has been selected out of the selectable candidates, the menu displaying unit 122 displays “1. read (Billy's) e-mail messages”, “2. Smartshop”, and “3. Staten Isl.” as more selectable candidates, on a menu screen 1207.

As explained above, the mobile phone terminal 100 according to the present embodiment has the supporting functions as described above. Thus, in conjunction with the sending of the e-mail message that has been created by the user while the user is traveling, the mobile phone terminal 100 allows the user to perform the following processes, for example, in a seamless manner: to check how long he/she needs to wait for a bus, which is related to the action the user is going to take next; to obtain the information about the destination.; and to make a phone call to a person whom the user is scheduled to meet.

Further, the updating and registering unit 119 makes new associations and updates the degrees of association for the keywords and the named entities that have been selected out of the selectable candidates by the user in the supporting function, while the keywords and the named entities are stored in the associated information storage unit 118.

In addition, there is a possibility that the mobile phone terminal 100 according to the present embodiment may have transitions of menu screens according to a procedure that is different from the processing procedure described above.

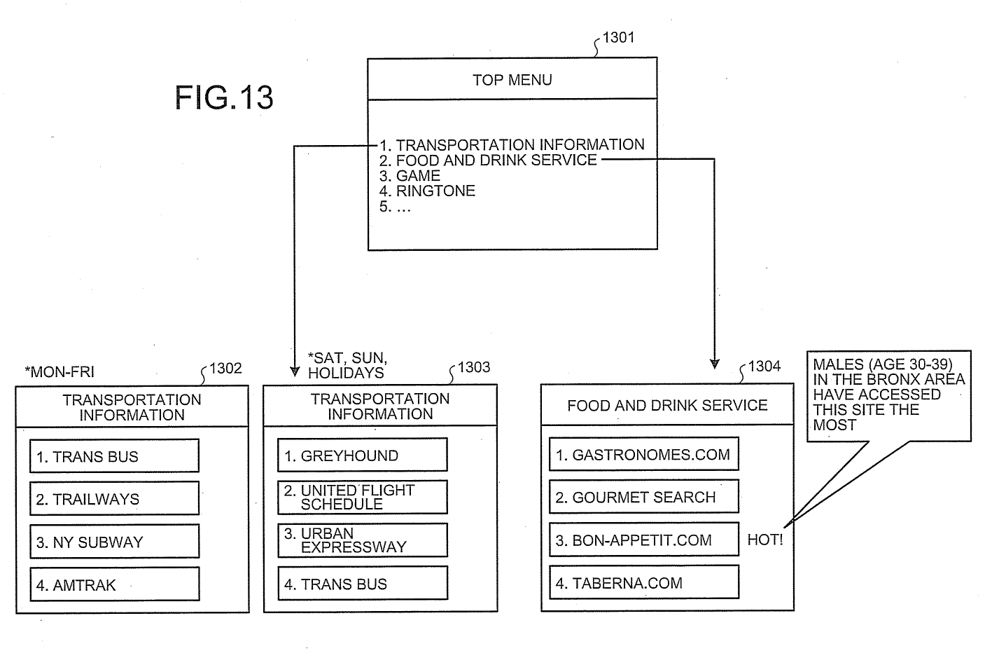

Shown in an example of a menu screen 1301 in FIG. 13 is an initial menu that is presumed to be a top menu screen on the mobile phone terminal 100 provided by the carrier or the provider or a collection of bookmarked links created by the user.

For example, in the case where the user has selected “1. Transportation Information”, the menu generating unit 121 refers to the associated information storage unit 108 so as to determine the level of frequency with which each of the means of transportation has been used and compares the day of the week, the date, and the time period of the day stored in the history as history of use, with the day of the week, the date, and the time period of the day of the current time. Thus, the menu generating unit 121 generates a menu screen 1302 or a menu screen 1303 on which the sites providing information of the means of transportation that has been referred to in a similar situation are arranged in an order. The menu displaying unit 122 then displays the generated menu screen.

As another example, in the case where the user has selected “2. Food and Drink Service.”, the menu generating unit 121 refers to the associated information storage unit 108 in the same manner and displays a menu screen 1304 on which the sites providing information are arranged in an order based on, for example, the levels of frequency with which the food and drink services have been used. Another arrangement is acceptable in which the information stored in the associated information storage unit 108 is used for a purpose other than determining the order in which the sites are arranged in the display. For example, of the attribute information of the user stored in the mobile phone terminal 100, some information (e.g., the gender or the age of the user) that is transmittable to an information provider (i.e., an external site) is specified in advance. By sending the specified information to the information provider (i.e., the external site), the menu displaying unit 122 displays sites and information that are popular among people who have the same attributes as the user, while marking the sites and the information with a sign reading, for example, “HOT!” or “NEW!”.

The sites and the information that are marked do not necessarily have to be ones that have the same attributes. For example, it is acceptable to display services, stores, and sites that are popular among male users or among female users in the same age group, or services and stores that are popular among each of different age groups.

By providing information to the user in this manner, it is possible to improve the operability during the searching process and the selection process. In addition, the content creators and the service providers are able to take the opportunity to build up their clientele by providing information to a targeted client group that is narrowed down.

Next, other examples of transitions of menu screens showing selectable candidates on the mobile phone terminal 100 according to the present embodiment will be explained.

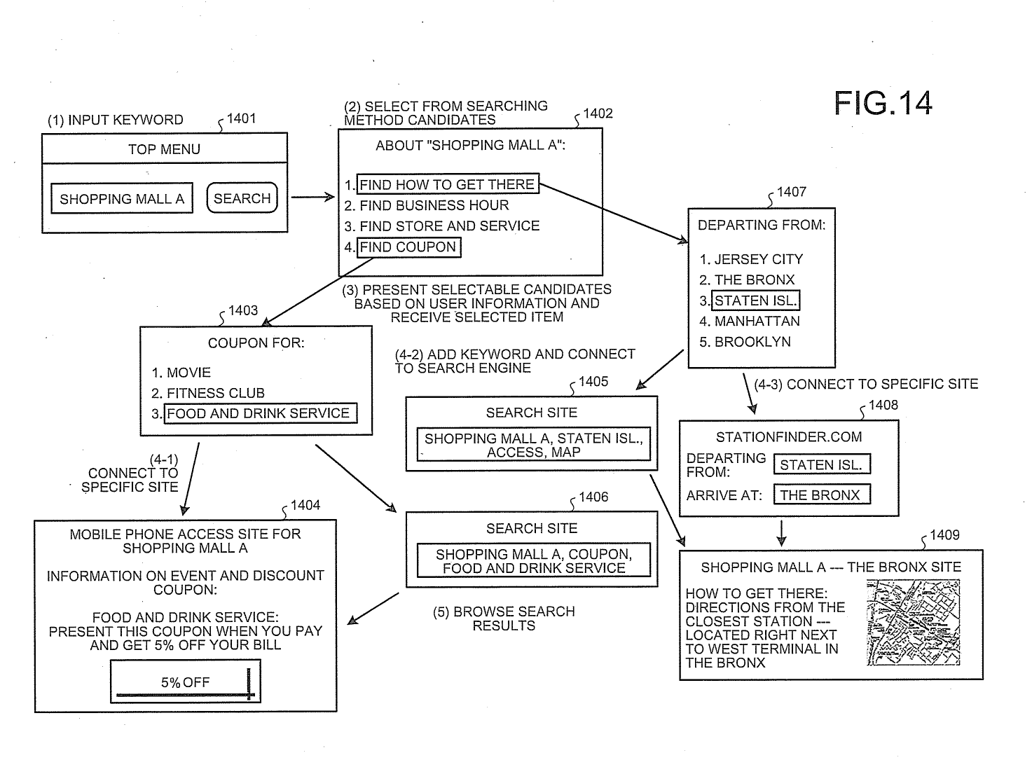

As shown in FIG. 14, on a menu screen 1401 displayed by the menu displaying unit 122, a search form in which the user is able to input a keyword is provided in the initial state.

The user inputs a keyword with which he/she wishes to conduct a search and presses the “search” button. As a result, as shown on a screen 1402, the menu displaying unit 122 displays selectable candidates for performing the task, based on a number of tasks that are defined in advance.

After that, when the user has selected one of the selectable candidates in which he/she is interested on the screen 1402, the menu generating unit 121 refers to the associated information storage unit 108 and generates a menu screen that is suitable for the user. For example, in the case where the user has selected the selectable candidate “Find how to get there”, the menu generating unit 121 generates a menu screen 1407 on which some of the place names and the addresses stored in the associated information storage unit 108 are arranged in descending order of the levels of frequency thereof. The menu displaying unit 122 then displays the menu screen 1407 that has been generated.

When the user has selected one of the place names out of the selectable candidates displayed on the menu screen 1407, the external site information forwarding unit 120 forwards the place name to the site to which the screen is switched, so that the communication processing unit 109 receives information from the external site. Accordingly, the displaying unit 125 displays the web page of the site. The site to which the screen is switched may be a site of any kind. For example, the site may be a search site like the one shown on a screen 1405 or a route searching site like the one shown on a screen 1408. After that, the displaying unit 125 displays a screen 1409 or the like, depending on the site to which the screen has been switched.

On the other hand, in the case where the user has selected the selectable candidate “Find coupon” on the menu screen 1402, the menu generating unit 121 refers to the associated information storage unit 108 and generates a menu screen 1403 on which genres of stores and services are arranged in descending order of the degrees of association thereof with the “Shopping Mall A”. The menu displaying unit 122 then displays the menu screen 1403 that has been generated.

After that, when the user has selected a desired one of the selectable candidates on the menu screen 1403, the external site information forwarding unit 120 automatically adds more keywords that correspond to the selectable candidate that has been selected to the “Shopping Mall A” that was initially input and forwards the selected selectable candidate and the added keywords to a search engine. As a result, a screen 1406 is displayed. Subsequently, a screen 1404 is displayed as a result of the search.

Another arrangement is acceptable in which, when the user has selected a desired one of the selectable candidates displayed on the menu screen 1403, the mobile phone terminal 100 establishes a connection to a site corresponding to the selected selectable candidate so that a screen 1404 showing the site is displayed.

In the description of the mobile phone terminal 100 according to first embodiment, the named entities on which the associating process is performed are extracted only from the contents and the application-stored information that have been referred to by the user; however, the first embodiment is not limited to this example. It is acceptable to extract the named entities from any document data as long as the document data is related to the user.

On the mobile phone terminal 100 configured as described above, the selectable candidates for which the levels of the user's interest are considered to be higher are displayed on the menu screen with higher priorities. Thus, it is possible to reduce the number of operations that the user is required to perform before reaching his/her desired selectable candidate. Consequently, it is possible to improve the operability.

In addition, as for the associated information storage unit 108 included in the mobile phone terminal 100, the information therein is updated and also more information is registered thereto, according to the operations performed by the user. Thus, the carrier or the service provider of the mobile phone terminal 100 does not need to store information into the mobile phone terminal 100 after associating pieces of information to one another in advance. Consequently, it is possible to reduce the labor load.

Further, in the case where the carrier or the service provider of a mobile phone terminal associates pieces of information to one another in advance and presents the information to the user, there is a possibility that the selectable candidates to be presented may be too much in detail for a specific keyword (e.g., a situation called “over-learning”). In that situation, the labor load is increased because the selectable candidates have to be narrowed down to more appropriate selectable candidates. However, in the mobile phone terminal 100 according to the present embodiment, when a menu screen is generated, the selectable candidates that have already been narrowed down are presented, based on the contents that have been referred to by the user and other selectable candidates that have already been selected by the user. Thus, it is possible to improve the browsability and to reduce the load of the user during the operation.

In addition, in the mobile phone terminal 100 according to the present embodiment, the information used for displaying the selectable candidates on the menu screen is stored in the associated information storage unit 108. In other words, the information is managed on the user side, not on the information provider side. Thus, it is possible to allow the information used in mutually different applications and mutually different sites to be utilized in a transversal manner. Consequently, it is possible to utilize information effectively and to display selectable candidates that are suitable for the user on the menu screen.

Further, according to the conventional technique, because of restrictions related to the display area on the screen of the mobile phone terminal 100 and the input device, the content creators and the service providers have been unable to appropriately provide information that corresponds to each of various attributes of different users. However, according to the embodiment, the content creators and the service providers are able to provide information by using the information stored in the associated information storage unit 108. Consequently, it is possible to increase the chances to build up their clientele.

Furthermore, when the user has input proper nouns and the like such as place names, names of organizations, and people's names to the mailer or the scheduler included in the mobile phone terminal 100, the information is stored into the associated information storage unit 108. Accordingly, when another application or a menu screen is displayed, the stored information is used. Thus, the user does not have to input or search for the information. Consequently, it is possible to reduce the load during the operation.

As explained above, the mobile phone terminal 100 according to the present embodiment is able to reduce the user's load during the operation to conduct searches. Also, the mobile phone terminal 100 allows the user to reach his/her desired information easily.

In addition, in the mobile phone terminal 100 according to the present embodiment, the named entities, the keywords, and the like are extracted from the contents to which the user has referred and the application-stored information, and the degrees of association are calculated among the extracted named entities and the like and stored into the associated information storage unit 108. Thus, it is possible to create dictionaries that can be used in information searches conducted by the user, with a high level of precision and at a low cost. Further, it is possible to offer the input support and the search support that can be used while the applications and the services are used, without any prior preparations or registrations by the user or the content providers. Furthermore, by using the associated information storage unit 108 that is included in the mobile phone terminal 100, the content creators are able to provide the information that is customized for each user.

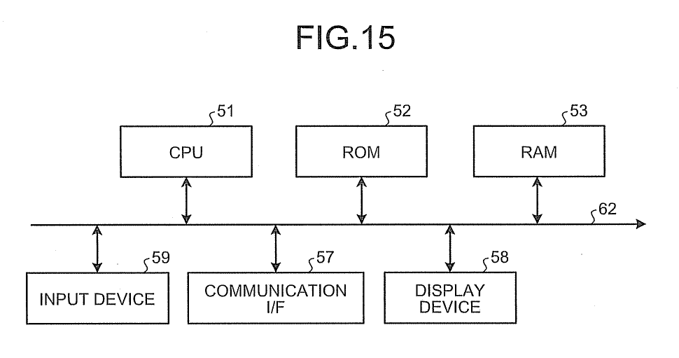

As shown in FIG. 15, the mobile phone terminal 100 according to the present embodiment includes, as its hardware configuration, a Read-Only Memory (ROM) 52 that stores therein a candidate displaying computer program that performs the processes described above; a Central Processing Unit (CPU) 51 that controls the constituent elements of the mobile phone terminal 100 according to the program stored in the ROM 52; a Random Access Memory (RAM) 53 that serves as a data storage area; a communication interface (I/F) 57 that establishes a connection to a network and performs communication; an input device 59; a display device 58; and a bus 62 that connects these constituent elements to one another.

Another arrangement is acceptable in which the candidate displaying computer program is provided as being recorded on a computer-readable recording medium such as a Compact Disk Read-Only Memory (CD-ROM), a floppy (registered trademark) disk (FD), a Digital Versatile Disk (DVD) or the like, in a file that is in an installable format or in an executable format.

In that situation, the candidate displaying computer program is loaded into the RAM 53 as being read from the recording medium and executed within the mobile phone terminal 100 so that the constituent elements that are explained in the description of the software configuration above are generated in the RAM 53.

Yet another arrangement is acceptable in which the candidate displaying computer program according to the exemplary embodiments described above is stored in a computer connected to a network like the Internet, so that the candidate displaying computer program is provided as being downloaded via the network.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A candidate displaying apparatus comprising:
an input unit that inputs document data;
an extracting unit that extracts, from the document data, named entities each identifying a specific object or a specific piece of information;
an calculating unit that calculates a degree of association indicating how strong an association is between each of the named entities and a predetermined character string contained in the document data;
an associated information storage unit that stores therein the named entities, the character string, and the degrees of associations in correspondence with one another; and
a candidate displaying unit that, when displaying the character string, displays the named entities in correspondence with the character string on a display device as selectable candidates in descending order of the degree of association thereof.

2. The apparatus according to claim 1, further comprising
a selection receiving unit that receives one of the selectable candidates that has been selected, and
an updating unit that updates the degree of association between the selected one of the selectable candidates and the character string.

3. The apparatus according to claim 2, further comprising a forwarding unit that forwards, to an external apparatus, the selected one of the selectable candidates that has been received by the selection receiving unit as a keyword to be used in a search.

4. The candidate displaying apparatus according to claim 1, further comprising
a stored information storage unit that stores therein stored information used by an application provided by the candidate displaying apparatus, wherein
the calculating unit further calculates a degree of association indicating how strong an association is between each of the extracted named entities and a character string contained in the stored information.

5. The apparatus according to claim 1, further comprising
an impression expression extracting unit that extracts, from the document data, impression expressions each of which indicates a level of interest with respect to a different one of the named entities, wherein
the calculating unit calculates the degrees of association based on the impression expressions regarding the named entities.

6. The apparatus according to claim 5, further comprising
an impression expression storage unit that stores therein the impression expressions and pieces of degree information that are kept in correspondence with one another, each of the pieces of degree information expressing, in terms of degrees, a different one of the levels of interest indicated by the impression expressions, wherein
the calculating unit calculates the degrees of association, based on the impression expressions regarding the named entities and the pieces of the degree information that are stored in the impression expression storage unit in correspondence with the impression expressions.

7. The apparatus according to claim 1, further comprising
a relation expression extracting unit that extracts, from the document data, relation expressions each of which indicates an attribute of a different one of the named entities, wherein
the associated information storage unit further stores therein the named entities that have been extracted from the document data and the attributes indicated by the relation expressions, while the named entities and the attributes are associated with one another, and also stores therein attribute information of a user of the candidate displaying apparatus, and
the candidate displaying unit displays the named entities on the display device as the selectable candidates, the named entities being associated with the attribute information of the user.

8. The apparatus according to claim 7, wherein the relation expression extracting unit extracts, from the document data, the relation expressions each of which indicates one of a group to belong to, a gender, and an age group represented by a different one of the named entities, as the attribute of the named entity.

9. The apparatus according to claim 1, wherein the a calculating unit calculates the degree of association between each of the extracted named entities and the character string by using one or more of bias values that are different from each other, according to a level of frequency with which each of the named entities is used and a type of each of the names entities.

10. The apparatus according to claim 1, further comprising
a stored information storage unit that stores therein pieces of stored information used by an application provided by the candidate displaying apparatus, and
a stored information obtaining unit that obtains, from the stored information storage unit, one of the pieces of stored information that is associated with the document data on which the input process has been performed by the input unit, wherein
the extracting unit extracts the named entities from the document data and the one of the pieces of stored information.

11. The apparatus according to claim 1, wherein the predetermined character string represents a named entity other than the each of the named entities.

12. A candidate displaying method comprising:
performing an input process on document data;
extracting, from the document data, named entities each identifying a specific object or a specific piece of information;
calculating a degree of association indicating how strong an association is between each of the named entities and a predetermined character string contained in the document data;
storing, the named entities, the character string, and the degrees of associations in correspondence with one another; and
displaying, when displaying the character string on a display device, the named entities in correspondence with the character string as selectable candidate in descending order of the degree of association thereof.

13. The method according to claim 12, further comprising
receiving one of the selectable candidates that has been selected, and
updating the degree of association between the selected one of the selectable candidates and the character string.

14. The method according to claim 13, further comprising forwarding, to an external apparatus, the selected one of the selectable candidates that has been received in the receiving as a keyword to be used in a search.

15. The method according to claim 12, further comprising
secondly storing pieces of stored information used by an application provided by a candidate displaying apparatus, and,
the calculating includes secondly calculating a degree of association indicating how strong an association is between each of the extracted named entities and a character string contained in the stored information stored in the secondly storing.

16. The method according to claim 12, further comprising
secondly extracting, from the document data, impression expressions each of which indicates a level of interest with respect to a different one of the named entities, wherein
the calculating includes calculating the degrees of association based on the impression expressions regarding the named entities.

17. The method according to claim 16, wherein,
the calculating includes calculating, the degrees of association based on the impression expressions regarding the named entities and pieces of degree information each of which expresses, in terms of degrees, a different one of the levels of interest indicated by the impression expressions, the impression expressions and the pieces of degree information being kept in correspondence with one another.

18. The method according to claim 12, further comprising
thirdly extracting, from the document data, relation expressions each of which indicates an attribute of a different one of the named entities, wherein
the storing includes storing, the named entities that have been extracted from the document data and the attributes indicated by the relation expressions, while the named entities and the attributes are associated with one another, and also storing attribute information of a user of a candidate displaying apparatus, and
the displaying includes displaying the named entities on the display device as the selectable candidates, the named entities being associated with the attribute of the user.

19. The method according to claim 18, wherein
the thirdly extracting includes extracting, from the document data, the relation expressions each of which indicates one of a group to belong to, a gender, and an age group represented by a different one of the named entities, as the attribute of the named entity.

20. The method according to claim 12, wherein
the calculating includes calculating the degree of association between each of the extracted named entities and the character string by using one or more of bias values that are different from each other, according to a level of frequency with which each of the named entities is used and a type of each of the names entities.
